(19) United States
(12) Patent Application Publication
(10) Pub. No.: US 2024/0289379 A1
(43) Pub. Date: Aug. 29, 2024

(54) INFORMATION PROCESSING DEVICE, INFORMATION PROCESSING METHOD, AND NON-TRANSITORY COMPUTER-READABLE STORAGE MEDIUM STORING PROGRAM

(71) Applicant: SEIKO EPSON CORPORATION, Tokyo (JP)

(72) Inventor: Shinichi TSURUYAMA, SHIOJIRI-SHI (JP)

(21) Appl. No.: 18/587,457

(22) Filed: Feb. 26, 2024

(30) Foreign Application Priority Data
Feb. 27, 2023 (JP) 2023-028143

(51) Int. Cl. G06F 16/535; G06F 3/12; G06F 16/93; G06T 11/60; G10L 15/22; G10L 15/30

(52) U.S. Cl. CPC G06F 16/535; G06F 3/1293; G06F 16/93; G06T 11/60; G10L 15/22; G10L 15/30

(57) ABSTRACT

According to an aspect of the present disclosure, an information processing device includes an acquisition unit, a search unit, and a generator. The acquisition unit acquires record data which is a record about a predetermined date inputted by voice. The search unit searches for image data, based on the record data acquired by the acquisition unit. The generator combines the record data and the image data together and thus generates document data.

The present application is based on, and claims priority from JP Application Serial Number 2023-028143, filed Feb. 27, 2023, the disclosure of which is hereby incorporated by reference herein in its entirety.

### BACKGROUND

### 1. Technical Field

The present disclosure relates to an information processing device, an information processing method, and a non-transitory computer-readable storage medium storing a program.

### 2. Related Art

JP-A-2008-250584 discloses an image file management device aiming to suitably categorize and sort out a plurality of image files so that the image files can be easily found based on date information. The image file management device described in JP-A-2008-250584 has an input unit, a search unit, a generation unit, and a saving unit. The input unit is a unit that inputs search guidance information including date information about a date with a touch pen and a button group. The search unit searches through a plurality of image files to find an image file created on a day corresponding to the date information included in the search guidance information inputted by the input unit. The generation unit sets a layout to display or print an image saved in the image file found by the search unit and generates a layout information file including the search guidance information inputted by the input unit and drawing information representing the layout. The saving unit saves the layout information file generated by the generation unit in the same storage medium as the image file found by the search unit.

The image file management device described in JP-A-2008-250584 can generate a document with a date such as a diary but has room for improvement in terms of convenience because a user needs to hold the touch pen and manually input information thereto. Therefore, the development of a technique that can improve convenience when generating a document with a date such as a diary is desired.

### SUMMARY

According to an aspect of the present disclosure, an information processing device includes: an acquisition unit that acquires record data which is a record about a predetermined date inputted by voice; a search unit that searches for image data, based on the record data; and a generation unit that combines the record data and the image data together and thus generates document data.

According to another aspect of the present disclosure, an information processing method includes causing an information processing device to: acquire record data which is a record about a predetermined date inputted by voice; search for image data, based on the record data; and combine the record data and the image data together and thus generate document data.

According to still another aspect of the present disclosure, a non-transitory computer-readable storage medium storing a program is provided. The program causes a compute to execute processing of: acquiring record data which is a record about a predetermined date inputted by voice; searching for image data, based on the record data; and combining the record data and the image data together and thus generating document data.

### BRIEF DESCRIPTION OF THE DRAWINGS

FIG. 1 is a block diagram showing an example of the configuration of an information processing system including an information processing device according to an embodiment.

FIG. 2 is a flowchart for explaining an example of document generation processing executed in the information processing system shown in FIG. 1.

FIG. 3 is a schematic view showing an example of a document generated in the information processing system shown in FIG. 1.

FIG. 4 is a schematic view showing another example of the document generated in the information processing system shown in FIG. 1.

FIG. 5 is a block diagram showing another example of the configuration of the information processing system including the information processing device according to the embodiment.

FIG. 6 is a sequence chart for explaining an example of document provision processing executed in the information processing system shown in FIG. 5.

FIG. 7 is a sequence chart for explaining another example of the document provision processing executed in the information processing system shown in FIG. 5.

FIG. 8 shows an example of the hardware configuration of a device.

### DESCRIPTION OF EMBODIMENTS

An embodiment of the present disclosure will now be described with reference to the drawings. The drawings are simply illustrations for explaining the embodiment of the present disclosure. Not all the elements described in the embodiment of the present disclosure are necessarily essential elements of the present disclosure.

### EMBODIMENT

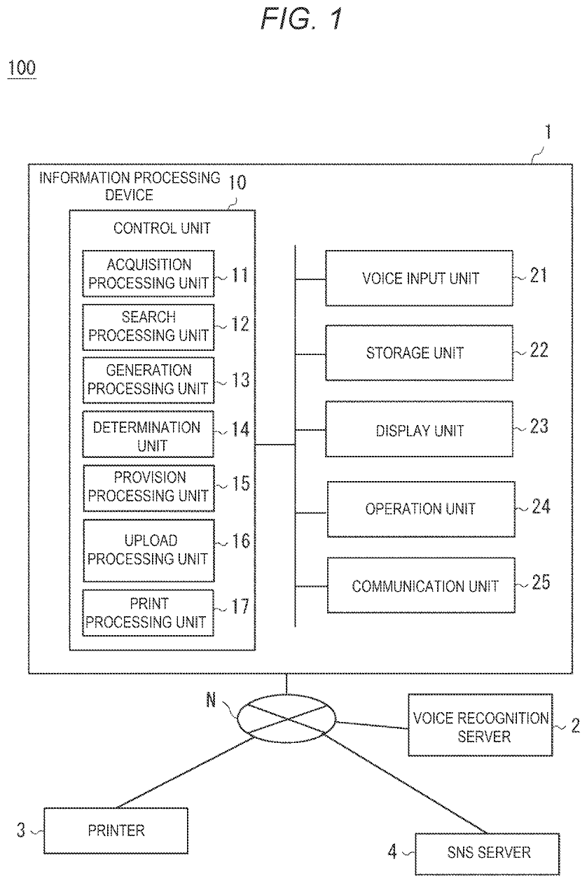

An information processing system including an information processing device according to this embodiment will be described with reference to FIG. 1. FIG. 1 is a block diagram showing an example of the configuration of this information processing system.

As shown in FIG. 1, an information processing system 100 according to this embodiment is a system that can include an information processing device 1, a voice recognition server 2, a printer 3, and an SNS (social networking service) server 4, and that can execute document generation processing as information processing. The information processing device 1, the voice recognition server 2, the printer 3, and the SNS server 4 can be connected via one or a plurality of networks N.

The information processing device 1 can be an information processing device having a communication function, such as a personal computer (PC), a smartphone or a tablet terminal, and is responsible for a main part of the document generation processing. The document generation processing will be described later. The information processing device 1 can also be referred to as a document generation device.

As shown in FIG. 1, the information processing device 1 can include a control unit 10, a voice input unit 21, a storage unit 22, a display unit 23, an operation unit 24, and a communication unit 25.

Although specific functions of the control unit 10 will be described later, the control unit 10 can include an acquisition processing unit 11, a search processing unit 12, and a generation processing unit 13 in order to generate document data. The control unit 10 can also include a determination unit 14 in order to generate document data that matches the user of the information processing device 1 or the voice projected by the user.

The control unit 10 can also include a provision processing unit 15, an upload processing unit 16, and a print processing unit 17 in order to perform processing up to the provision of document data. The provision processing unit 15, the upload processing unit 16, and the print processing unit 17 may be not provided when the information processing device 1 is configured as a device that performs processing up to the generation of document data. Meanwhile, when the information processing device 1 is configured as a device that performs processing up to the provision of document data, for example, one or a plurality of the provision processing unit 15, the upload processing unit 16, and the print processing unit 17 may be provided.

The control unit 10 can be configured, for example, including a computational processing device such as a CPU (central processing unit) or a GPU (graphics processing unit), a work memory, and a storage device storing a control program and a parameter or the like. The control unit 10 can also be configured as a SoC (system on a chip). As can be understood from these examples, the control unit 10 can be configured to store the control program in an executable state. However, the control unit 10 can also be configured as a circuit configuration such as an FPGA (field-programmable gate array) to store the control program or can be configured as a dedicated circuit. The acquisition processing unit 11, the search processing unit 12, the generation processing unit 13, the determination unit 14, the provision processing unit 15, the upload processing unit 16, and the print processing unit 17 can be installed as the foregoing program. The foregoing program can include a program for the computational processing device to implement the functions of the units 11 to 17 in cooperation with the voice input unit 21, the storage unit 22, the display unit 23, the operation unit 24, and the communication unit 25.

The voice input unit 21 inputs voice data of a user in order to generate document data. The voice input unit 21 can be formed of a microphone.

The storage unit 22 is a storage device made up of, for example, a hard disk drive, a solid-state drive, or another memory. A part of the memory provided in the control unit 10 may be regarded as the storage unit 22. That is, the storage unit 22 can be regarded as a part of the control unit 10.

The storage unit 22 can store various data handled by the information processing device 1, for example, inputted voice data, text data as a result of voice recognition of the voice data, data of a template for document data to be generated, generated document data, and the like. The storage unit 22 can also store various user settings or the like for the information processing device 1.

The display unit 23 is a section to display a user interface image in order to generate document data and is formed of, for example, a display device such as a liquid crystal display or an organic electroluminescence display. The display unit 23 can also be configured including a display and a drive circuit to drive the display.

The operation unit 24 is a section to accept an operation or an input from the user and can also be referred to as an operation accepting unit. The operation unit 24 can be implemented, for example, by one or a plurality of a physical button, a touch panel installed in the display unit 23, a pointing device, and a keyboard or the like. In a configuration where the operation unit 24 has a touch panel, the operation unit 24 including the display unit 23 and the touch panel can be referred to as an operation panel of the information processing device 1.

The communication unit 25 can be one or a plurality of communication interfaces to execute communication with one or a plurality of external devices via a wire or wirelessly in conformity with a predetermined communication protocol including a predetermined communication standard. The information processing system 100 can include the voice recognition server 2, the printer 3, and the SNS server 4 as such external devices.

The voice recognition server 2 recognizes voice data received from an external device such as voice data inputted by the voice input unit 21, converts the voice data into text data, and returns the text data to the external device. The external device in this case includes the information processing device 1. The voice recognition server 2 can also execute voice recognition processing, using a learned model that is machine-learned to input voice data and output text data. The algorithm or the like of this learned model is not particularly limited. For example, a deep neural network or the like configured to machine-learn, establishing a correspondence between a voice and a text, can be used. The voice recognition server 2 can also be a voice assistant server that provides a service such as search by voice. The language used for voice recognition may be automatically detected or can be set in advance by the user.

The printer 3 is an example of an image forming device and can print print data on a medium when receiving the print data from the information processing device 1. The print data to be received can be data formed of document data converted by the information processing device 1 into a format that is printable by the printer 3. Of course, the information processing system 100 can have a plurality of printers and can enable the user to select a printer to execute printing. The image forming device may be any device having a communication function and a print function and may be a multifunction peripheral having other functions such as a scanner function and a copy function. The printing method in the image forming device is not particularly limited. For example, various printing methods such as an inkjet printing method and a laser printing method can be employed.

The SNS server 4 is a server forming a system that provides a social networking service and can store and release document data received from an external device.

The generation and provision of document data executed by the information processing device 1 according to this embodiment will now be described in detail.

First, the processing up to the generation of document data is described.

The user projects a voice including a date. The voice input unit 21 inputs this voice as voice data and hands over the voice data to the control unit 10. The user can speak about an event whose content is to be included in document data, or the like.

The control unit 10 causes the storage unit 22 store this voice data or directly causes the acquisition processing unit 11 to operate. In connection with a predetermined date, the user can determine a date even without designating a specific date such as today or yesterday. Not only a date but also time or a time bracket such as morning or afternoon can be included in the voice data.

The acquisition processing unit 11 transmits the voice data inputted by the voice input unit 21 to the voice recognition server 2 via the communication unit 25 and requests voice recognition processing. The voice recognition server 2 executes the voice recognition processing and converts the foregoing voice data into text data. The acquisition processing unit 11 acquires the text data. The text data is record data which is a record about a predetermined date inputted by voice. The record data includes the designation of a date and therefore can also be referred to as diary data, journal data, or the like. The voice input unit 21, the acquisition processing unit 11, the communication unit 25, and the voice recognition server 2 are an example of an acquisition unit that acquires record data which is a record about a predetermined date inputted by voice.

The information processing device 1 can be configured to be able to perform processing up to the generation of document data in a single device. In this case, the information processing device 1 may have the voice recognition function described as the function of the voice recognition server 2.

The search processing unit 12 searches for image data, based on the record data acquired by the acquisition processing unit 11. The search processing unit 12 can temporarily save the image data found by the search in the storage unit 22 in order to generate document data.

One or a plurality of search destinations can be decided in advance. Also, the user can designate or change a search destination. The search destination may be the storage unit 22, the SNS server 4, a server (not illustrated) from which image data can be downloaded, or the like. To execute a search via the network N, the search processing unit 12 executes the search via the communication unit 25. That is, the search processing unit 12 can perform processing of searching for image data, based on the record data, from a device connected to the information processing device 1 via the network. The search processing unit 12 and the storage unit 22, or the search processing unit 12, the communication unit 25, and the storage unit 22, are an example of a search unit that searches for image data, based on record data.

The search processing unit 12 can also acquire image data from the record data, using a learned model that is machine-learned to input record data and output image data. The search processing unit 12 can also have a function of extracting a keyword from the record data. The function can be provided in the learned model. However, otherwise, the search processing unit 12 can extract one or a plurality of keywords from the record data and acquire image data from each keyword or a combination of a plurality of keywords, using a learned model that is machine-learned to input the keyword and output image data.

The algorithm or the like of this learned model is not particularly limited. For example, a deep neural network or the like configured to machine-learn, establishing a correspondence between a text and an image, can be used. When the search processing unit 12 uses the learned model, the learned model may be stored in the storage unit 22 or may be stored in a server, not illustrated, that is connected to the network N.

The generation processing unit 13 combines the record data and the image data together and thus generates document data. The document data includes an image such as a picture or a photograph as the image data and therefore can be referred to as picture diary data, photo diary data, or the like.

The technique of combining the record data and the image data together is not particularly limited. For example, the generation processing unit 13 can read out one of one or a plurality of templates stored in advance in the storage unit 22, allocate a text represented by the record data to a text field in the template, and paste the image data to an image pasting field in the template. The generation processing unit 13 and the storage unit 22 are an example of a generation unit that combines record data and image data together and thus generates document data.

The generation processing unit 13 can also use the text itself represented by the record data, as a text in the document data. In the description below, the text in the document data to be generated and the data representing the text are referred to as a diary text and diary text data, respectively. However, since the record data is data that is originally inputted by voice, the generation processing unit 13 may make a suitable modification to the record data such as proofreading the diary text or adding an associated text and use the modified record data as the diary text. The generation processing unit 13 can also be configured in such a way that the user can designate in advance what level of formality is used to generate the diary text, for example, in Japanese, whether to use a formal style called “desu-masu style” or a colloquial style, or the like.

The generation of the diary text data from the record data as described above can also be executed, using a learned model that is machine-learned to output diary text data from record data or from one or a plurality of keywords extracted from the record data. The algorithm or the like of this learned model is not particularly limited. For example, a deep neural network or the like configured to machine-learn, establishing a correspondence between a keyword and a diary text, can be used. When the generation processing unit 13 uses the learned model, the learned model may be stored in the storage unit 22 or may be stored in a server, not illustrated, that is connected to the network N.

It is also conceivable that the initially acquired record data does not provide an amount of information that is enough to generate document data including a certain level of content. Therefore, the acquisition processing unit 11 can output a voice or a text to provide the user with question data to acquire additional information to generate the document data, based on the initially acquired record data. The acquisition processing unit 11 then acquires additional record data, which is an answer inputted by voice in response to the question data, in a course similar to the course of acquiring the record data.

In this case, the search processing unit 12 may search for image data, based on the record data and the additional record data. The generation processing unit 13 may combine the record data, the additional record data, and the image data together, and thus may generate document data. Asking the user a question and increasing the amount of information in this way enables the generation of content-rich document data. Asking a question as described in this case can be repeated according to the answer. Also, the information processing device 1 may have a voice output unit formed of a speaker or the like in order to give a voice output of such a question.

Such a question-and-answer session can be executed, using a learned model that is machine-learned to output question data from record data or from the record data and an already acquired answer. The algorithm or the like of this learned model is not particularly limited. For example, a deep neural network or the like configured to machine-learn, establishing a correspondence between a keyword included in record data or the like and a question to acquire necessary information, can be used. When the search processing unit 12 uses the learned model, the learned model may be stored in the storage unit 22 or may be stored in a server, not illustrated, that is connected to the network N.

In many cases, a text typified by a diary includes a description of weather. Therefore, the record data can include region data representing a region inputted by voice. In this case, the search processing unit 12 may perform processing of searching for weather data representing the weather in the region on a predetermined date, based on the region data. The generation processing unit 13 may combine the record data, the weather data, and the image data together, and thus may generate document data. The weather data can be acquired, for example, from a server (not illustrated) connected to the network N and recording weather. However, for example, if the weather data is stored in the storage unit 22, the weather data may be acquired from the storage unit 22.

The region data can also be acquired as additional record data acquired through a question-and-answer session. In this case, for example, when the record data does not include information representing the region or the weather, a question about the region may be asked and an answer may be acquired.

Alternatively, the search processing unit 12 may search for weather data representing the weather in a set region on a predetermined date, based on region data representing the set region that is preset. When the record data includes data representing a region inputted by voice, the search processing unit 12 may search for weather data representing the weather in the region on a predetermined date, instead of the weather in the set region. In this case, too, the generation processing unit 13 may combine the record data, the weather data, and the image data together, and thus may generate document data.

If the generated document data includes a text corresponding to the emotion and level of knowledge of the user, the document data can be easily used as document data created by the user. To this end, the control unit 10 can have the determination unit 14.

The determination unit 14 can be provided in order to generate document data corresponding to the emotion of the user of the information processing device 1. The determination unit 14 determines the level of inflection of the voice that is the source of the record data. The method for determining the level of inflection is not particularly limited. The level of inflection of the voice can be determined, based on a change in intonation, a change in volume, or the like. A learned model can be used for this determination as well. The determination unit 14 may add the level of inflection to a corresponding part of the record data.

The generation processing unit 13 generates document data in such a way that the content included in the generated document data varies in response to the level determined by the determination unit 14. Thus, the diary text of the generated document data can be, for example, a text of a cheerful content if it is a voice with inflection like a cheerful voice, or a text of a gloomy content if it is a voice without inflection like a gloomy voice.

A learned model can also be used for the generation of document data from the record data with the level of inflection added. That is, the generation processing unit 13 can execute the generation of document data, using a learned model that is machine-learned to output diary text data, or diary text data and image data, from the record data or from one or a plurality of keywords extracted from the record data. The algorithm or the like of this learned model is not particularly limited. For example, a deep neural network or the like configured to machine-learn, establishing a correspondence between a keyword and a diary text, can be used. When the generation processing unit 13 uses the learned model, the learned model may be stored in the storage unit 22 or may be stored in a server, not illustrated, that is connected to the network N.

The level of inflection can also be used for the search for the image data to be included in the document data. For example, the search processing unit 12 can execute the search, using a learned model that is machine-learned to output image data from the record data with the level of inflection added or from one or a plurality of keywords extracted from the record data. Thus, the image included in the generated document data can be, for example, an image of a smile if it is a voice with inflection like a cheerful voice, or an image of a gloomy expression if it is a voice without inflection like a gloomy voice.

The determination unit 14 can also determine an attribute of an inputter inputting the voice that is the source of the record data, in addition to or instead of the level of inflection. In this example, the inputter can be the user of the information processing device 1. As the attribute, various attributes such as age, gender, birthplace, and location can be employed. Information representing the attribute can be set in advance by the user or can be acquired by analyzing the voice data. For this analysis, for example, a learned model that is machine-learned to input voice data and output an attribute can be used. The location can be acquired by a position information acquisition unit (not illustrated) additionally incorporated in the information processing device 1. The position information acquisition unit acquires the position of the information processing device 1 that is the place of installation of an antenna, using a position information acquisition system such as the GPS (Global Positioning System).

The generation processing unit 13 generates document data in such a way that the content included in the generated document data varies according to the attribute determined by the determination unit 14. Thus, for example, when the inputter is a male child, an image of a boy is included in the document data. Meanwhile, when the inputter is a female child, an image of a girl is included in the document data.

The provision of the generated document data will now be described.

The provision processing unit 15 provides the document data to another information processing device (not illustrated) via the communication unit 25. Thus, the user can provide the document data to the another information processing device used by another person and thus can show the document data to the another person.

The upload processing unit 16 uploads the document data to the SNS server 4 via the network. Thus, the document data is registered in a viewable state at the SNS server 4. The upload processing unit 16 executes the upload via the communication unit 25.

The print processing unit 17 performs processing of transmitting an instruction to print the document data to the printer 3 via the network. The print processing unit 17 converts the document data into print data which is in a format printable by the printer 3, and instructs the printer 3 to print via the communication unit 25 with a print request. The printer 3 is thus enabled to print the document data. Even when the destination of the instruction from the print processing unit 17 is not the printer 3 itself and is a virtual printer in a print server (not illustrated) providing a print service at the printer 3, the printer 3 is similarly enabled to print. When the information processing device 1 has the print processing unit 17, the information processing device 1 can also be referred to as a print control device.

The information processing device 1 can also be configured to accept, from the operation unit 24, a setting about which of the provision processing unit 15, the upload processing unit 16, and the print processing unit 17 is defined as a provision destination of the document data, and provide the document data to the provision destination according to the setting. The information processing device 1 can be configured to execute this setting before the generation of the document data, but can also be configured to execute the setting after the generation or can be configured to change the setting.

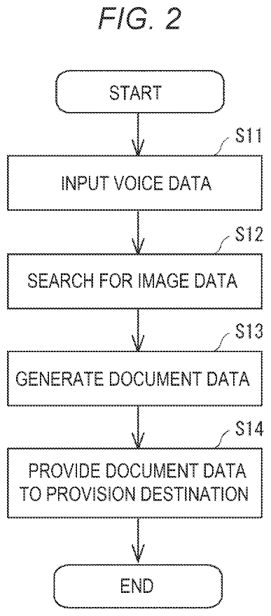

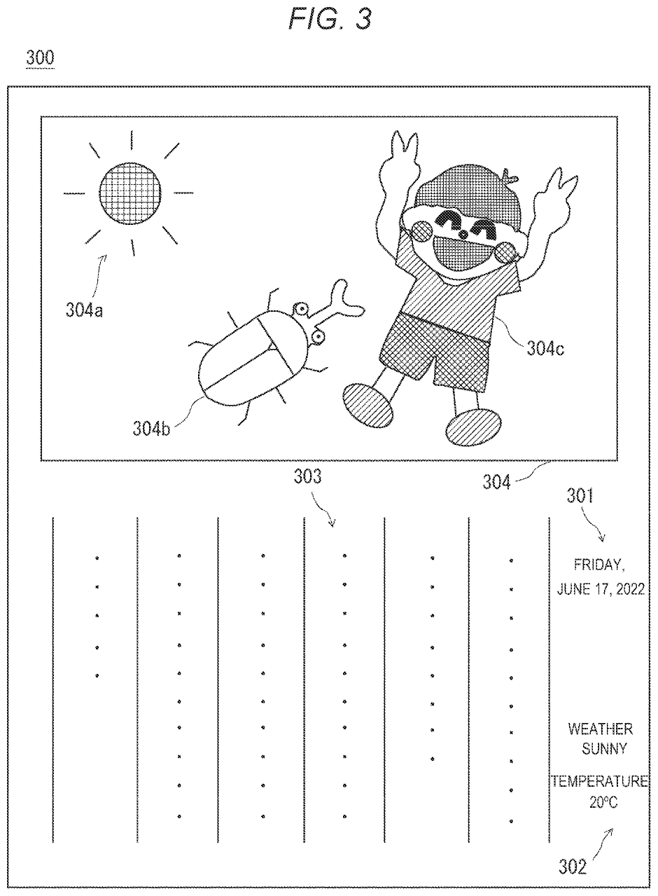

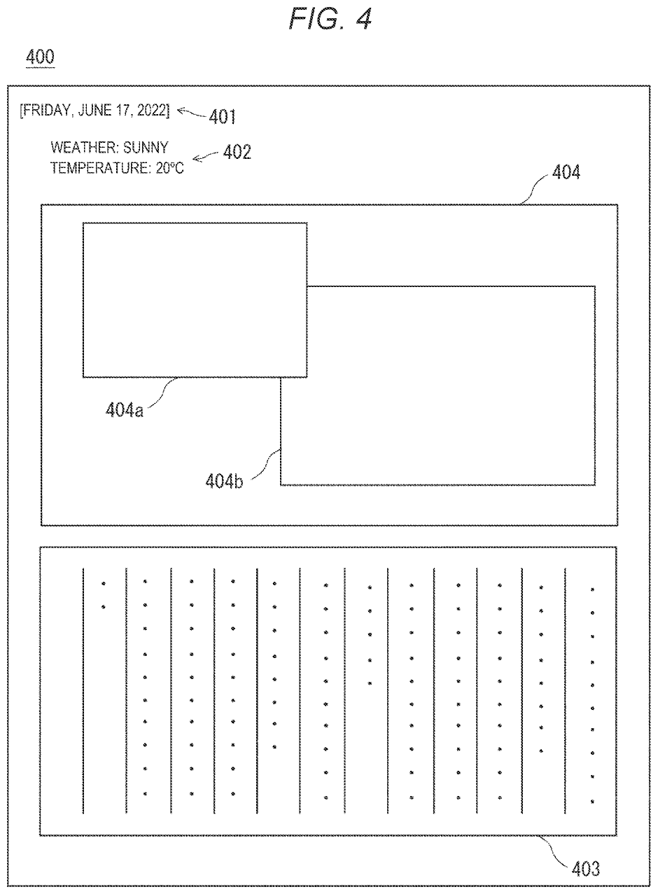

The document generation processing executed in the information processing system 100 will now be described with reference to FIGS. 2 to 4, using a specific example of the document represented by the generated document data. FIG. 2 is a flowchart for explaining an example of the document generation processing executed in the information processing system 100. FIG. 3 is a schematic view showing an example of the document generated in the information processing system 100. FIG. 4 is a schematic view showing another example of the document generated in the information processing system 100.

The information processing device 1 first acquires record data which is a record about a predetermined date inputted by voice (step S11) and searches for image data, based on the record data (step S12). The information processing device 1 then combines the record data and the image data together, thus generates document data (step S13), provides the document data to a provision destination (step S14), and ends the processing. In each of steps S11 to S14, the various application examples described above about the information processing device 1 can be applied.

By such processing, the information processing device 1 can generate, for example, document data represented by a document 300 shown in FIG. 3 and can provide the document data to the provision destination. The document 300 includes information showing that it is Friday, Jun. 17, 2022, as date information 301, and also includes information showing that it is sunny and that the temperature is 20.0° C., as weather information 302 at the beginning of a diary text 303. Although not illustrated, the diary text 303 includes a text corresponding to the content of the voice input by the user.

For example, when a boy in lower grades of elementary school inputs voices of “I caught a beetle”, “the beetle was large”, and “I was happy”, the diary text 303 may be, for example, “I caught a huge beetle! (break) I was very happy! (break) Woo-hoo!!” or the like. In this case, a template and a letter font suitable for a boy in lower grades of elementary school can be used in the document 300. Also, as an image 304 to match such a voice input, an image including an illustration 304a of the sun, an illustration 304b of a beetle, and an illustration 304c of a person corresponding to the content is included in the document 300.

The document 300 can be a so-called picture diary. A photograph can be used instead of an illustration. Also, after the document data is generated, the user can use a picture for coloring so as to be able to color the document, from a client 5 or on a piece of paper when the document data is printed.

In another example, the information processing device 1 can generate, for example, document data represented by a document 400 shown in FIG. 4 and can provide the document data to the provision destination. The document 400 includes information showing that it is Friday, Jun. 17, 2022, as date information 401, and also includes information showing that it is sunny and that the temperature is 20.0° C., as weather information 402 at the beginning of the document 400. Although not illustrated, a diary text 403 includes a text corresponding to the content of the voice input by the user. For example, when an adult female person inputs a voice, the diary text 403 can be a longer text than the diary text 303 included in the document 300 even if the content of the voice input is equivalent.

A template and a letter font suitable for an adult female person can be used in the document 400. Also, an image 404 such as an image where photographs 404a, 404b corresponding to the content of the voice input are neatly laid out can be included in the document 400. The photographs 404a, 404b can be, for example, photographs picked up by the user with a camera, not illustrated, and stored in the storage unit 22, photographs uploaded to the SNS server 4, or the like.

As described above, in the information processing system 100, when generating a document with a date such as a diary, the user need not hold a touch pen and manually input information. Therefore, convenience can be improved. In the information processing system 100, for example, by having a conversation, the user can easily generate a picture diary that is homework during summer break or the like. This can help a child who is not good at drawing or a child who is not good at writing, and thus leads to a reduction in the time taken for this homework and an increase in the time available for another homework or play, and hence an improvement in the lifestyle of the child. Since the generated picture diary can be automatically posted on an SNS or the like, the user can leave a memorable diary more easily than before. Also, for example, if document data is generated based on voice data recorded in advance in a voice recorder, an image can be linked to the recorded content easily and in a short time.

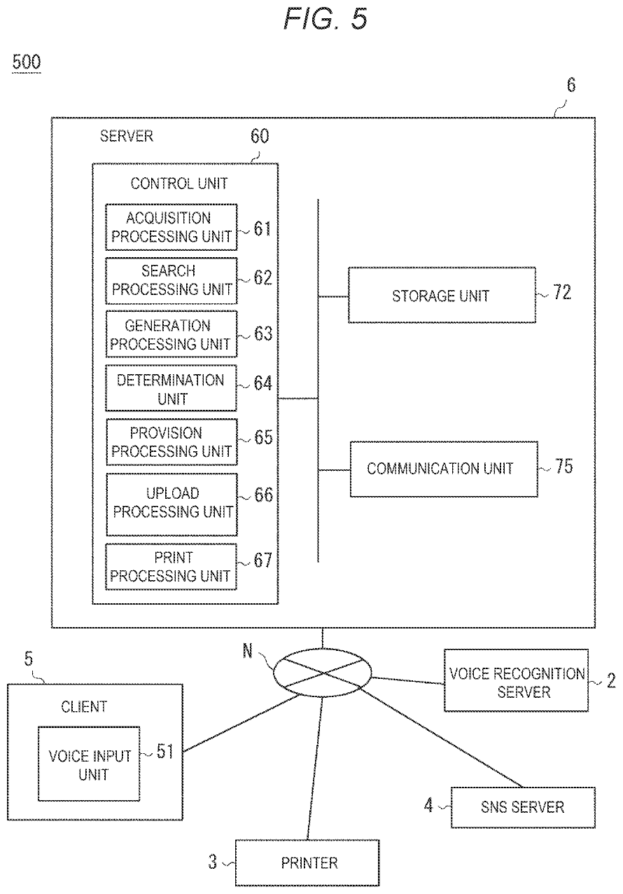

Another example of the configuration of the information processing system including the information processing device according to this embodiment will now be described with reference to FIG. 5. FIG. 5 is a block diagram showing another example of the configuration of the information processing system including the information processing device according to this embodiment.

An information processing system 500 according to the configuration example shown in FIG. 5 is a system that can include a server 6, a client 5, a voice recognition server 2, a printer 3, and an SNS server 4, and that can execute document generation processing as information processing. The server 6, the client 5, the voice recognition server 2, the printer 3, and the SNS server 4 can be connected via one or a plurality of networks N.

The server 6 can be an information processing device having a communication function, such as a computer, and is responsible for a main part of the document generation processing. This document generation processing is basically similar to the processing described as the document generation processing in the information processing device 1 shown in FIG. 1 but differs in the system configuration. Therefore, the document generation processing in this example differs from the processing described as the document generation processing in the information processing device 1 shown in FIG. 1 at least in the transmission and reception of data. The server 6 can also be referred to as a document generation server.

As shown in FIG. 5, the server 6 can include a control unit 60, a storage unit 72, and a communication unit 75, corresponding to the control unit 10, the storage unit 22, and the communication unit 25, respectively.

Although specific functions of the control unit 60 will be described later, the control unit 60 can include an acquisition processing unit 61, a search processing unit 62, and a generation processing unit 63 in order to generate document data. The control unit 60 can also include a determination unit 64 in order to generate document data that matches the user of the client 5 or the voice projected by the user.

The control unit 60 can include a provision processing unit 65, an upload processing unit 66, and a print processing unit 67 in order to provide document data. The provision processing unit 65, the upload processing unit 66, and the print processing unit 67 may be not provided when the server 6 is configured as a server that performs processing up to the generation of document data. Meanwhile, when the server 6 is configured as a server that performs processing up to the provision of document data, for example, one or a plurality of the provision processing unit 65, the upload processing unit 66, and the print processing unit 67 may be provided.

The control unit 60 can be configured, for example, including a computational processing device such as a CPU or a GPU, a work memory, and a storage device storing a control program and a parameter or the like. The control unit 60 can also be configured as a SoC. As can be understood from these examples, the control unit 60 can be configured to store the control program in an executable state. However, the control unit 60 can also be configured as a circuit configuration such as an FPGA to store the control program or can be configured as a dedicated circuit. The acquisition processing unit 61, the search processing unit 62, the generation processing unit 63, the determination unit 64, the provision processing unit 65, the upload processing unit 66, and the print processing unit 67 can be installed as the foregoing program. The foregoing program can include a program for the computational processing device to implement the functions of the units 61 to 67 in cooperation with the storage unit 72 and the communication unit 75.

The storage unit 72 is a storage device made up of, for example, a hard disk drive, a solid-state drive, or another memory. A part of the memory provided in the control unit 60 may be regarded as the storage unit 72. That is, the storage unit 72 can be regarded as a part of the control unit 60.

The storage unit 72 can store various data handled by the server 6, for example, voice data received from the client 5, text data as a result of voice recognition of the voice data, data of a template for document data to be generated, generated document data, and the like. The storage unit 72 can also store settings or the like for various processing at the server 6.

The communication unit 75 can be one or a plurality of communication interfaces to execute communication with one or a plurality of external devices via a wire or wirelessly in conformity with a predetermined communication protocol including a predetermined communication standard. The information processing system 500 can include the client 5, the voice recognition server 2, the printer 3, and the SNS server 4 as such external devices.

The client 5 is an information processing device having a communication function, such as a PC, a smartphone or a tablet terminal, and is a terminal device used by a user requesting the generation of document data. Although not illustrated, the client 5 can also have an operation unit and a display unit as an interface for operations, as well as a control unit controlling the entirety of the client 5, and a communication unit. The operation unit and the display unit are configured similarly to the operation unit 24 and the display unit 23 shown in FIG. 1.

The client 5 can also have a voice input unit 51. The voice input unit 51 is, similarly to the voice input unit 21, a section that inputs voice data of the user in order to generate document data, and can be formed of a microphone.

The generation and provision of document data executed by the server 6 according to this embodiment will now be described briefly. Details and application examples thereof are similar to those described with respect to the information processing device 1 shown in FIG. 1.

First, the processing up to the generation of document data is described.

The user of the client 5 projects a voice including a date. The voice input unit 51 inputs this voice as voice data and transmits the voice data to the server 6. The server 6 receives the voice data via the communication unit 75 and hands over the voice data to the control unit 60. The control unit 60 causes the storage unit 72 store this voice data or directly causes the acquisition processing unit 61 to operate.

The acquisition processing unit 61 transmits the voice data received from the client 5 to the voice recognition server 2 via the communication unit 75 and requests voice recognition processing. The voice recognition server 2 executes the voice recognition processing and converts the foregoing voice data into text data. The acquisition processing unit 61 acquires the text data. The text data is record data which is a record about a predetermined date inputted by voice. The communication unit 75, the acquisition processing unit 61, and the voice recognition server 2 are an example of an acquisition unit that acquires record data which is a record about a predetermined date inputted by voice, from another information processing device connected via the network N.

The server 6 can be configured to be able to perform processing up to the generation of document data in a single device. In this case, the server 6 may have the voice recognition function described as the function of the voice recognition server 2.

Alternatively, the client 5 can access the voice recognition server 2 and acquire the text data, and the acquisition processing unit 61 can be configured to acquire the text data from the client 5 or from the voice recognition server 2. In this case, the client 5 transmits the voice data inputted from the voice input unit 51 to the voice recognition server 2 and requests voice recognition processing. The voice recognition server 2 executes the voice recognition processing and converts the foregoing voice data into text data. The voice recognition server 2 transmits the text data to the server 6 or transmits the text data to the client 5, and the client 5 can acquire the text data and transmit the text data to the server 6. In this case, the communication unit 75 and the acquisition processing unit 61 are an example of an acquisition unit that acquires record data which is a record about a predetermined date inputted by voice, from another information processing device connected via the network N.

The search processing unit 62 searches for image data, based on the record data acquired by the acquisition processing unit 61. The search processing unit 62 can temporarily save the image data found by the search in the storage unit 72 in order to generate document data. Again, the search destination can be the storage unit 72, the SNS server 4, a server (not illustrated) from which image data can be downloaded, or the like. One or a plurality of search destinations can be decided in advance. Also, the user can designate or change a search destination.

The generation processing unit 63 combines the record data and the image data together and thus generates document data. If the generated document data includes a text corresponding to the emotion and level of knowledge of the user, the document data can be easily used as document data created by the user. To this end, the control unit 60 can have the determination unit 64. The generation processing unit 63 can generate document data in such a way that the content included in the generated document data varies according to the level and the attribute of the user determined by the determination unit 64.

Also, this example is similar to the information processing device 1 shown in FIG. 1 in that the search processing unit 62, the generation processing unit 63, the determination unit 64, and the like, can perform processing, using a learned model according to need.

The provision of the generated document data will now be described.

The provision processing unit 65 in the configuration example shown in FIG. 5 provides the document data to the client 5 as another information processing device via the communication unit 75. Thus, the user can save the document data or view the document data later, at the client 5. Of course, the another information processing device may be an information processing device other than the client 5.

The upload processing unit 66 uploads the document data to the SNS server 4 via the network. The print processing unit 67 performs processing of transmitting an instruction to print the document data to the printer 3 via the network. The printer 3 is thus enabled to print the document data.

The server 6 can also be configured to accept, from the client 5, a setting about which of the provision processing unit 65, the upload processing unit 66, and the print processing unit 67 is defined as a provision destination of the document data, and provide the document data to the provision destination according to the setting. The server 6 can be configured to execute this setting before the generation of the document data, but can also be configured to execute the setting after the generation or can be configured to change the setting.

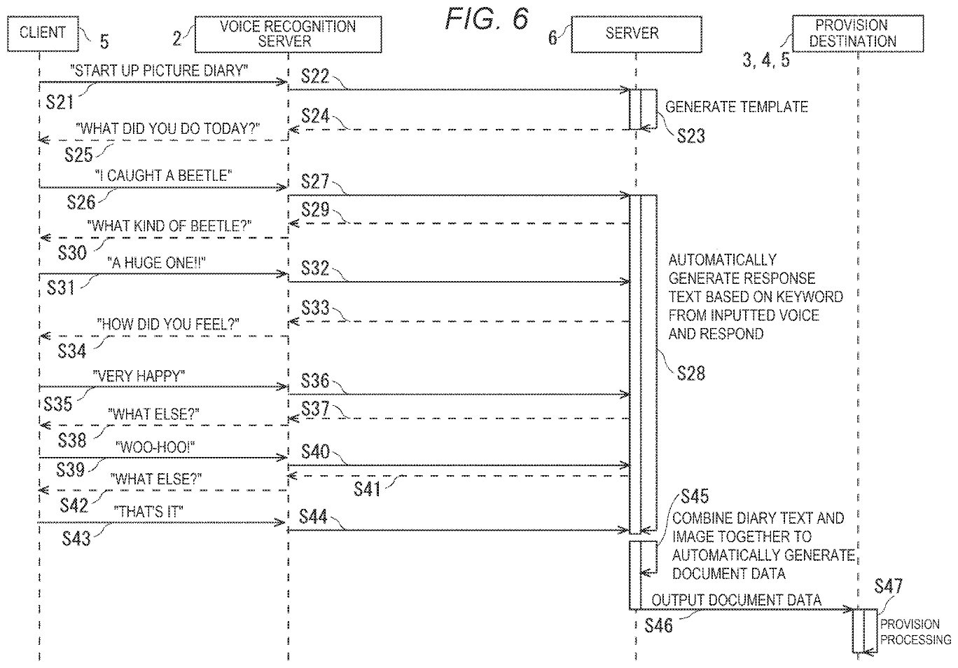

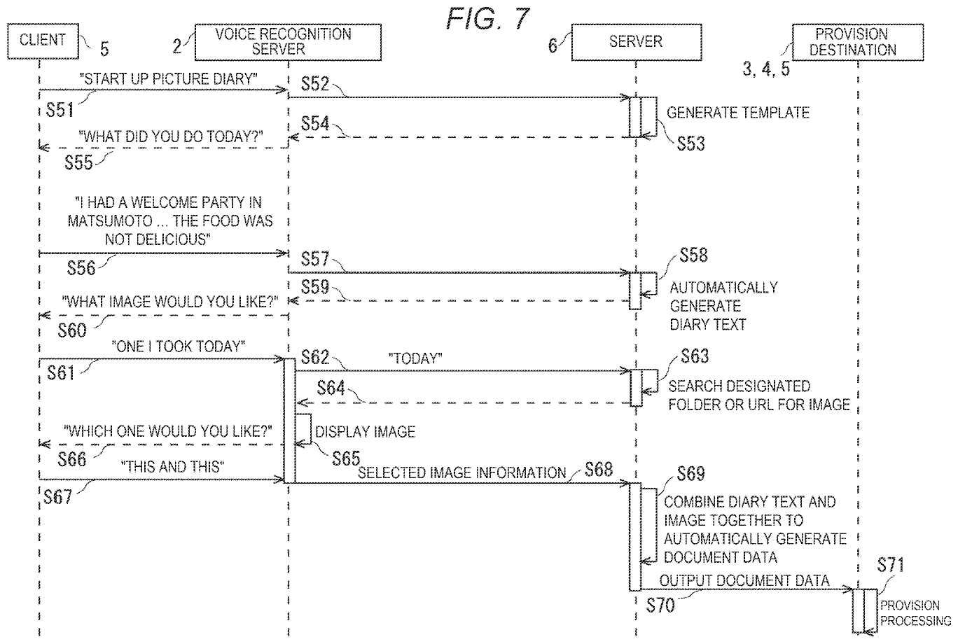

An example of the document provision processing executed in the information processing system 500 shown in FIG. 5 where the document 300 shown in FIG. 3 is generated and provided will now be described with reference to FIG. 6. FIG. 6 is a sequence chart for explaining an example of the document provision processing executed in the information processing system 500 shown in FIG. 5. The sequence chart of FIG. 6 and the sequence chart of FIG. 7, described later, show an example where the client 5 transmits voice data to the voice recognition server 2 and where the server 6 acquires converted text data.

The user first utters, “Start up picture diary”, using the client 5, and the client 5 inputs voice data of the utterance and transmits the voice data to the voice recognition server 2 (step S21). The document provision processing is thus started. The voice recognition server 2 converts the voice data into text data, recognizes that it is the start of the document provision processing, based on the text data, and notifies the server 6 to that effect (step S22). Next, the server 6 executes the generation or the reading of a template for document data (step S23). For example, when the user of the client 5 is a boy in lower grades of elementary school, this template can be a template that matches the attributes of the user.

Next, the server 6 transmits a message prompting the user to make an utterance about an event to the voice recognition server 2 in terms of supporting the generation of a diary (step S24). The voice recognition server 2 converts the message into voice data and transmits the voice data to the client 5 (step S25). This message can be, for example, a question message such as “What did you do today?”. However, a question such as “Diary of what day and month would you like to write?” may be asked and information about the date can thus be acquired. Also, the client 5 has a voice output unit formed of a speaker or the like in order to give a voice output of such a question message. In this way, a fixed phrase can be used for a response in the first question and answer, whereas from the second question and answer onward, a response can be given using the content of the answer(s) up to that point.

It is now assumed that the user utters, “I caught a beetle”, and that the client 5 transmits voice data of the utterance to the voice recognition server 2 (step S26). The voice recognition server 2 converts the voice data into text data and transmits the text data to the server 6 (step S27). From this point, the server 6 extracts a keyword included in the text data, based on the text data represented by the result of the text conversion of the inputted voice, automatically generates a response text, and then responds (step S28).

By the processing of step S28 based on the text data received in step S27, the server 6 transmits, for example, a question text such as “What kind of beetle?” to the voice recognition server 2 (step S29). The voice recognition server 2 converts the question text into voice data and transmits the voice data to the client 5 (step S30). The client 5 gives a voice output. Similarly, when the user answers, “A huge one!!”, the client 5 transmits voice data of the answer to the voice recognition server 2 (step S31). The voice recognition server 2 converts the voice data into text data and transmits the text data to the server 6 (step S32).

Similarly, the server 6 transmits a question text such as “How did you feel?” to the voice recognition server 2 (step S33). The voice recognition server 2 converts the question text into voice data and transmits the voice data to the client 5 (step S34). The client 5 gives a voice output. Similarly, when the user answers, “Very happy”, the client 5 transmits voice data of the answer to the voice recognition server 2 (step S35). The voice recognition server 2 converts the voice data into text data and transmits the text data to the server 6 (step S36).

Similarly, the server 6 transmits a question text such as “What else?” to the voice recognition server 2 (step S37). The voice recognition server 2 converts the question text into voice data and transmits the voice data to the client 5 (step S38). The client 5 gives a voice output. Similarly, when the user answers, “Woo-hoo!”, the client 5 transmits voice data of the answer to the voice recognition server 2 (step S39). The voice recognition server 2 converts the voice data into text data and transmits the text data to the server 6 (step S40).

Similarly, the server 6 transmits a question text such as “What else?” to the voice recognition server 2 (step S41). The voice recognition server 2 converts the question text into voice data and transmits the voice data to the client 5 (step S42). The client 5 gives a voice output. Similarly, when the user answers, “That's it”, the client 5 transmits voice data of the answer to the voice recognition server 2 (step S43). The voice recognition server 2 converts the voice data into text data and transmits the text data to the server 6 (step S44). When the server 6 receives text data meaning the end such as “That's it”, the server 6 ends the question and answer processing of step S28.

Next, the server 6 executes the generation of a diary text and the search for an image, based on the acquired text data, then combines the diary text and the image together, and thus automatically generates document data (step S45). Thus, document data such as the document 300 shown in FIG. 3 is generated. Since an utterance that can be understood to have a high level of inflection is made in step S39, a smiling expression is employed in an illustration showing the attributes of the user, as the illustration 304c. To post an illustration of the user, an illustration generated by modifying a photograph image of the user, if any, can be used.

Next, the server 6 provides the generated document data to the provision destination (step S46). The provision destination can be one or a plurality of the printer 3, the SNS server 4, and the client 5, as described above. In response to this, the provision destination executes the provision processing of the document data (step S47).

Another example of the document provision processing executed in the information processing system 500 shown in FIG. 5 where the document 400 shown in FIG. 4 is generated and provided will now be described with reference to FIG. 7. FIG. 7 is a sequence chart for explaining another example of the document provision processing executed in the information processing system 500 shown in FIG. 5.

As the user first utters, “Start up picture diary”, using the client 5, processing similar to steps S21 to S25 is performed (steps S51 to S55). However, for example, when the user of the client 5 is an adult female person, the template generated in step S53 can be a template that matches the attributes of the user.

It is now assumed that the user utters, “I had a welcome party in Matsumoto . . . . The food was not delicious”, and that the client 5 transmits voice data of the utterance to the voice recognition server 2 (step S56). The voice recognition server 2 converts the voice data into text data and transmits the text data to the server 6 (step S57). From this point, the server 6 can perform automatic response processing as described with reference to step S28. In the description below, for the sake of convenience, it is assumed that the voice data transmitted in step S56 is enough to fill a diary text. After step S57, the server 6 automatically generates a diary text, based on the received text data (step S58). Since an utterance that can be understood to have a low level of inflection is made in step S56, a text of a gloomy content is described as the diary text 403.

Next, the server 6 can request the user to designate an image and therefore transmits, for example, a question text such as “What image would you like?” to the voice recognition server 2 (step S59). The voice recognition server 2 coverts the question text into voice data and transmits the voice data to the client 5 (step S60). The client 5 gives a voice output. When the user answers, “One I took today”, and voice data of the answer is transmitted (step S61), the voice recognition server 2 converts the voice data into text data and transmits a text representing “today” as a necessary keyword to the server 6 (step S62).

The server 6 receives this text and searches a place designated in advance for an image saved today (step S63). The place designated in advance can be, for example, a folder within the client 5, a folder within the server 6 designated in advance, a URL (Uniform Resource Locator) of a cloud server (not illustrated) designated in advance, or the like. This designation may be the designation by the user. Also, the designated place can be found by asking a question. The server 6 can also be configured to enable the selection of an image content, a time stamp, and a tag from a designated image group by a user operation.

The server 6 transmits the image data of the search result to the voice recognition server 2 (step S64). The voice recognition server 2 displays images represented by the image data in a state viewable from the client 5 (step S65). The voice recognition server 2 then transmits voice data of a question text such as “Which one would you like?” to the client 5 (step S66). The client 5 gives a voice output. The question text such as “Which one would you like?” may be decided in advance as a default question to allow the user to select an image. Also, text data of the question text may be received from the server 6.

Next, the user gives an answer that can designate an image or images, such as “This and this”. The client 5 transmits voice data of the answer to the voice recognition server 2 (step S67). The voice recognition server 2 receives the voice data, converts the voice data into text data, designates the selected image, based on the text, and transmits information representing the designated selected image to the server 6 (step S68).

Next, the server 6 combines together the diary text generated in step S58 and the image designated in step S68 and thus automatically generates document data (step S69). Thus, document data such as the document 400 shown in FIG. 4 is generated.

Next, the server 6 provides the generated document data to the provision destination (step S70). The provision destination can be one or a plurality of the printer 3, the SNS server 4, and the client 5, as described above. In response to this, the provision destination executes the provision processing of the document data (step S71).

The examples described with reference to FIGS. 5 to 7 can achieve effects similar to the effects of the example described with reference to FIG. 1 and the like. Also, the information processing system 500 can be constructed as a system using the server 6. Therefore, the system can be used by many users.

### Other Modification Examples

The present disclosure is not limited to the foregoing embodiment and can be changed according to need without departing from the spirit and scope of the present disclosure. For example, each of the information processing device 1, the voice recognition server 2, the SNS server 4, the client 5, and the server 6 illustrated in FIGS. 1 and 5 may be any device that can implement functions as described above. Each of the information processing device 1, the voice recognition server 2, the SNS server 4, the client 5, and the server 6 is not limited to being configured as a single device but can be constructed as a distributed system where the functions of the device are distributed to a plurality of devices. In the present specification, the server can refer to a server computer but can also be regarded as a server program.

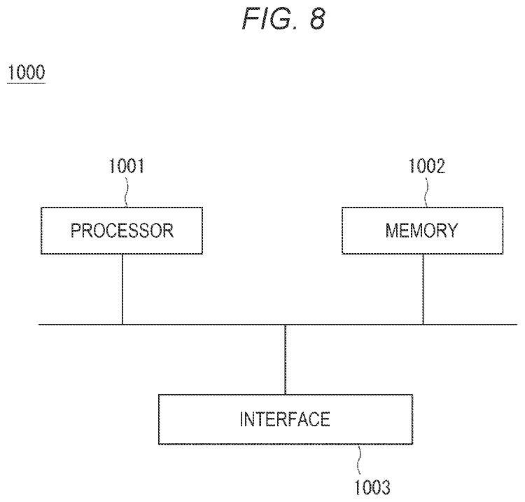

Each device provided in the information processing system according to the foregoing embodiment can have, for example, a hardware configuration as described below. In the examples shown in FIGS. 1 and 5, this each device may be the information processing device 1, the voice recognition server 2, the printer 3, the SNS server 4, the client 5, and the server 6. Of course, each of the information processing device 1, the voice recognition server 2, the SNS server 4, the client 5, and the server 6 can be constructed as a distributed system where the functions of the device are distributed to a plurality of devices. In that case, the foregoing each device can refer to each of the plurality of devices. FIG. 8 shows an example of the hardware configuration of a device.

A device 1000 shown in FIG. 8 can have a processor 1001, a memory 1002, and an interface 1003. The interface 1003 can include, for example, a communication interface and an interface with an input-output device or the like, according to the need of the device.

The processor 1001 may be, for example, a CPU, a GPU, an MPU (microprocessor unit) also referred to as a microprocessor, or the like. The processor 1001 may include a plurality of processors. The memory 1002 is formed of, for example, a combination of a volatile memory and a non-volatile memory. The functions of each device are implemented by the processor 1001 reading a program stored in the memory 1002 and executing the program while exchanging necessary information via the interface 1003. For example, when the device 1000 is an information processing device, this program can include a program for causing the processor 1001 to execute the document generation processing as described above.

The foregoing program includes a command set (or software code) for causing a computer to execute one or more of the functions described in the embodiment, when read by the computer. The program may be stored in a non-transitory computer-readable medium or in a tangible storage medium. The computer-readable medium or the tangible storage medium includes, for example but not limited to, a random-access memory (RAM), a read-only memory (ROM), a flash memory, a solid-state drive (SSD), or other memory techniques. Also, the computer-readable medium or the tangible storage medium includes, for example but not limited to, a CD-ROM, a digital versatile disc (DVD), a Blu-ray (trademark registered) disk or other optical disk storages, a magnetic cassette, a magnetic tape, a magnetic disk storage or other magnetic storage devices. The program may be transmitted on a transitory computer-readable medium or a communication medium. The transitory computer-readable medium or the communication medium includes, for example but not limited to, a propagating signal in an electrical, optical, acoustic, or other formats.

While the present disclosure has been described based on the foregoing embodiment, the present disclosure is not limited to the configurations in the embodiment, and as a matter of course, includes various changes, modifications, and combinations that can be made by a person skilled in the art within the scope of the present disclosure according to the claims of the present application.

What is claimed is:

1. An information processing device comprising:
an acquisition unit that acquires record data which is a record about a predetermined date inputted by voice;
a search unit that searches for image data, based on the record data; and
a generator that combines the record data and the image data together and thus generates document data.

2. The information processing device according to claim 1, wherein
the acquisition unit acquires the record data from another information processing device connected via a network.

3. The information processing device according to claim 1, wherein
the acquisition unit
outputs question data to acquire additional information to generate the document data, based on the acquired record data, and
acquires additional record data which is an answer inputted by voice in response to the question data,
the search unit searches for the image data, based on the record data and the additional record data, and
the generator combines the record data, the additional data, and the image data together, and thus generates the document data.

4. The information processing device according to claim 1, wherein
the record data includes region data representing a region inputted by voice,
the search unit searches for weather data representing weather in the region on the predetermined date, based on the region data, and
the generator combines the record data, the weather data, and the image data together, and thus generates the document data.

5. The information processing device according to claim 1, wherein
based on region data representing a set region that is set in advance, the search unit searches for weather data representing weather in the set region on the predetermined date, and
when the record data includes data representing a region inputted by voice, the search unit searches for weather data representing weather in the region on the predetermined date instead of the weather in the set region, and
the generator combines the record data, the weather data, and the image data together, and thus generates the document data.

6. The information processing device according to claim 1, wherein
the search unit acquires the image data from the record data, using a learned model that is machine-learned to input the record data and output the image data.

7. The information processing device according to claim 1, wherein
the search unit searches a device connected to the information processing device via a network for the image data, based on the record data.

8. The information processing device according to claim 1, further comprising:
a determination unit that determines a level of inflection of a voice that is a source of the record data, wherein
the generator generates the document data in such a way that a content included in the generated document data varies according to the level.

9. The information processing device according to claim 1, further comprising:
a determination unit that determines an attribute of an inputter inputting a voice that is a source of the record data, wherein
the generator generates the document data in such a way that a content included in the generated document data varies according to the attribute.

10. The information processing device according to claim 2, further comprising:
a provision processing unit that provides the document data to the another information processing device.

11. The information processing device according to claim 1, further comprising:
an upload processing unit that uploads the document data to a system of a social networking service via a network.

12. The information processing device according to claim 1, further comprising:
a print processing unit that transmits an instruction to print the document data to an image forming device via a network.

13. An information processing method comprising causing an information processing device to:
acquire record data which is a record about a predetermined date inputted by voice;
search for image data, based on the record data; and
combine the record data and the image data together and thus generate document data.

14. A non-transitory computer-readable storage medium storing a program, the program causing a compute to execute processing of:
acquiring record data which is a record about a predetermined date inputted by voice;
searching for image data, based on the record data; and
combining the record data and the image data together and thus generating document data.
